(19) United States
(12) Patent Application Publication
(10) Pub. No.: US 2023/0391275 A1
(43) Pub. Date: Dec. 7, 2023

(54) Vehicular Security Camera Assembly

(71) Applicant: Tara Soliz, Fresno, CA (US)

(72) Inventor: Tara Soliz, Fresno, CA (US)

(21) Appl. No.: 17/832,022

(22) Filed: Jun. 3, 2022

(51) Int. Cl. B60R 11/04; B60R 1/20; B60R 25/30; B60R 25/102; B60R 25/33; H04W 4/029; H04W 4/40

(52) U.S. Cl. CPC B60R 11/04; B60R 1/20; B60R 25/305; B60R 25/102; B60R 25/33; H04W 4/029; H04W 4/40; B60R 2011/0033

(57) ABSTRACT

A vehicular security camera assembly for visually recording and communicating with a third party includes a microprocessor integrated within the interior of a vehicle. The microprocessor has a transceiver engaging by wireless communication to an agent of an entity being a third party security company. A speaker is in electric communication with the microprocessor, and a microphone is in electric communication with the microprocessor as well. A camera system is in electric communication with the microprocessor. The camera system includes a rear camera and a roof camera for recording visuals within the interior of the vehicle. Furthermore, the camera system includes a pair of bumper cameras and a pair of mirror cameras for recording an exterior surrounding of the vehicle. Additionally, a start button is in electric communication with the microprocessor.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to vehicle security device and more particularly pertains to a new vehicle security device for visually recording and communicating with a third party.

### (2) Description of Related Art Including Information Disclosed Under 37 CFR 1.97 and 1.98

The prior art relates to vehicle security devices. The prior art relates to a variety of vehicle security devices comprising a camera and a transceiver to wirelessly communicate with a third party. Known prior art lacks a vehicle security device including a first transceiver and a second transceiver to wirelessly communicate with a third party and further comprising a plurality of interior cameras and a plurality of exterior cameras.

### (h) BRIEF SUMMARY OF THE INVENTION

An embodiment of the disclosure meets the needs presented above by generally comprising a microprocessor is integrated within the interior of a vehicle. The microprocessor is configured for being positioned in a rear view mirror of the vehicle. The microprocessor has a transceiver configured for engaging by wireless communication to an agent of an entity being a third party security company. A speaker is in electric communication with the microprocessor, and a microphone is in electric communication with the microprocessor as well. The microprocessor is configured for rendering information provided by the microphone. A camera system is in electric communication with the microprocessor. The camera system further includes a rear camera configured for being positioned on the rear view mirror of the vehicle. A pair of bumper cameras is configured for recording visuals of an exterior surrounding of the vehicle. A pair of mirror cameras is configured for being positioned on a respective one of a pair of side mirrors of the vehicle. A roof mirror is configured for being positioned on an interior surface of a roof of the vehicle. Additionally, a start button is in electric communication with the microprocessor.

Furthermore, a method of activating a vehicle security camera assembly includes the step of pressing a start button to actuate a camera system integrated within a moving vehicle. The camera system can be actuated by speaking a first command into a microphone. The first command is “begin recording.” A global positioning system unit of a transceiver of a microprocessor begins locating the vehicle relative to the Earth. The user calls an agent of an entity by speaking a second command into the microphone. The second command is “call agent.” The transceiver of the microprocessor begins to connect by wireless communication to the agent of the entity. The user communicates with the agent by speaking into the microphone and listening from a speaker.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a vehicular security camera assembly according to an embodiment of the disclosure.

FIG. 2 is a back isometric view of an embodiment of the disclosure.

FIG. 3 is an isometric view of a rear view mirror of an embodiment of the disclosure.

FIG. 4 is a side in-use view of an embodiment of the disclosure.

FIG. 5 is a box diagram view of an embodiment of the disclosure.

### (j) DETAILED DESCRIPTION OF THE INVENTION

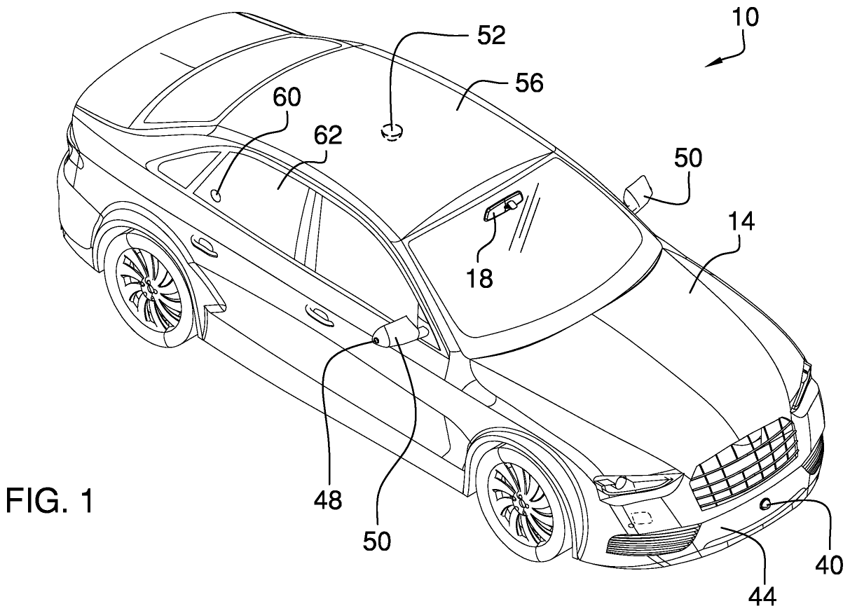

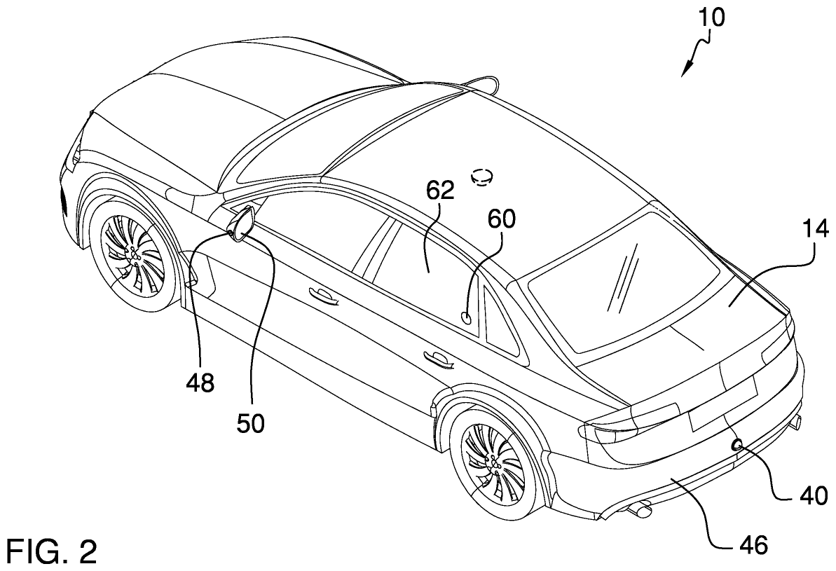

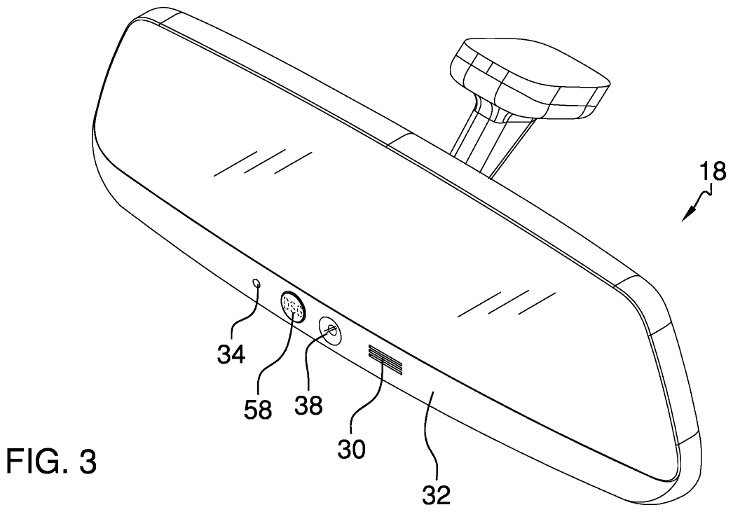

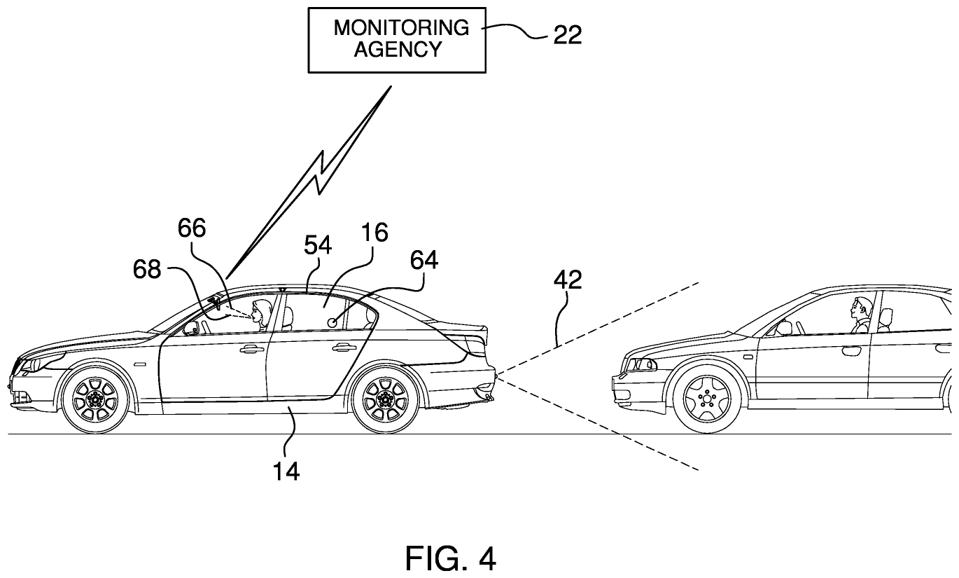

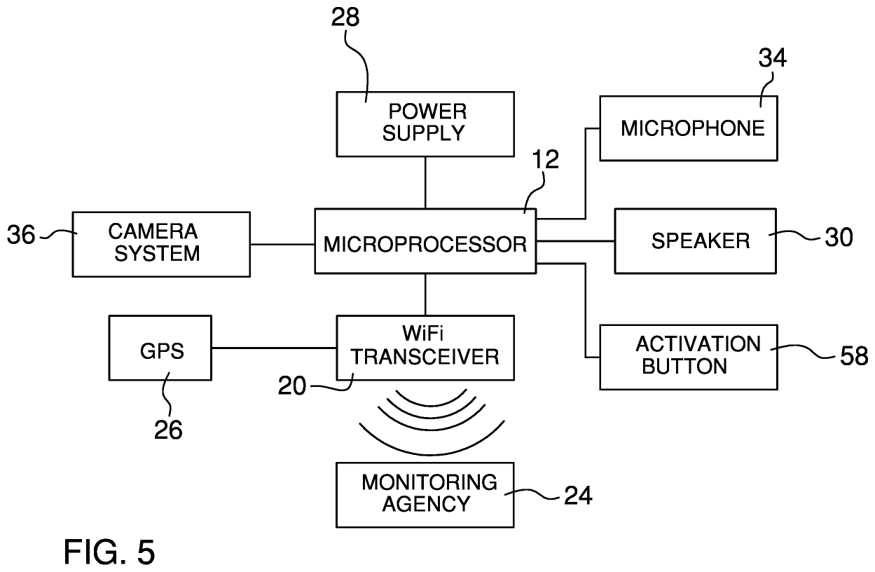

With reference now to the drawings, and in particular to FIGS. 1 through 5 thereof, a new vehicle security device embodying the principles and concepts of an embodiment of the disclosure and generally designated by the reference numeral 10 will be described.

As best illustrated in FIGS. 1 through 5, the vehicular security camera assembly generally comprises a microprocessor 12 being integrated within the interior 16 of a vehicle 14. The microprocessor 12 is configured for being positioned in a rear view mirror 18 of the vehicle 14 and rendering commands from the user to execute actions based on the commands. The microprocessor 12 has a transceiver 20 configured for engaging by wireless communication to an agent 22 of an entity 24, wherein the entity 24 is a third party security company. The transceiver 20 is configured for having a global positioning system unit 26. The global positioning system unit 26 is configured for locating the vehicle 14 relative to the Earth. The agent 22 is also in wireless communication with the global positioning system unit 26. Furthermore, the microprocessor 12 is configured for receiving electric power from a battery 28 of the vehicle 14.

A speaker 30 is in electric communication with the microprocessor 12. The speaker 30 produces audio output received from the agent 22 from the transceiver 20 of the microprocessor 12. The speaker 30 is configured for being positioned on a front surface 32 of the rear view mirror 18 of the vehicle 14. A microphone 34 is in electric communication with the microprocessor 12, wherein the microphone 34 is configured for receiving audio input from the user. The microprocessor 12 is configured for rendering information provided by the microphone 34. The microphone 34 is configured for being positioned on the front surface 32 of the rear view mirror 18 of the vehicle 14 proximate to the speaker 30.

A camera system 36 is in electric communication with the microprocessor 12. The camera system 36 is configured for being integrated with the vehicle 14. Furthermore, the camera system 36 includes a rear camera 38. The rear camera 38 is configured for being positioned on the front surface 32 of the rear view mirror 18 of the vehicle 14 proximate to both the speaker 30 and the microphone 34. The rear camera 38 is configured for recording visuals of the interior 16 of the vehicle 14. Alternately, a pair of bumper cameras 40 is configured for recording visuals of an exterior surrounding 42 of the vehicle 14.

Furthermore, each of the bumper cameras 40 is configured for being positioned on a respective one of a front bumper 44 of the vehicle 14 and the back bumper 46 of the vehicle 14. Each of the bumper cameras 40 is configured for recording visuals in a 360 degree range of motion. A pair of mirror cameras 48 is configured for being positioned on a respective one of a pair of side mirrors 50 of the vehicle 14 to further record visuals of the exterior surrounding 42 of the vehicle 14. Additionally, a roof camera 52 is configured for being positioned on an interior surface 54 of a roof 56 of the vehicle 14. The roof camera 52 is configured for recording visuals of the interior 16 of the vehicle 14 in a 360 degree range of motion, similar to each of the bumper cameras 40.

A start button 58 is in electric communication with the microprocessor 12. The start button 58 is an actuator configured for initiating recording of each camera of the camera system 36 of the vehicle 14. Furthermore, the start button 58 initiates the global positioning system unit 26 of the transceiver 20 to begin locating the vehicle 14 relative to the Earth. The start button 58 is configured for being positioned on the front surface 32 of the rear view mirror 18 of the vehicle 14. A pair of stickers 60 is configured for being coupled to a respective one of a pair of side windows 62 of the vehicle 14. Each of the stickers 60 couples to a respective one of each of the windows 62 by an adhesive material of a first side of each of the stickers 60. A second side of each of the stickers 60 has a logo 64 of the vehicular security camera assembly 10. The purpose of the pair of stickers is to inform other drivers of the vehicular security camera assembly 10 integrated within the vehicle 14.

In use, the user presses the start button 58 to actuate the camera system 36 integrated within the moving vehicle 14. Additionally, the camera system 36 can be actuated by speaking a first command 66 into the microphone 34. The first command 66 is “begin recording.” The global positioning system unit 26 of the transceiver 20 begins locating the vehicle 14 relative to the Earth. The user calls the agent 22 of the entity 24 by speaking a second command 68 into the microphone 34. The second command 68 is “call agent.” The transceiver 20 of the microprocessor 12 begins to connect by wireless communication to the agent 22 of the entity 24. The user communicates with the agent 22 by speaking into the microphone 34 and listening from the speaker 30. The global positioning system unit 26 is also in wireless communication with the agent 22 wherein the agent 22 can determine the location of the moving vehicle 14. The agent 22 is able to view the camera system 36 as well.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicular security camera assembly configured for recording both the exterior and interior of a vehicle, the vehicular security camera assembly comprising:
a microprocessor being integrated within an interior of a vehicle, said microprocessor being configured for being positioned in a rear view mirror of the vehicle, said microprocessor having a transceiver configured for engaging by wireless communication to an agent of an entity, said entity being a third party security company;
a speaker being in electric communication with said microprocessor;
a microphone being in electric communication with said microprocessor, said microprocessor being configured for rendering information provided by said microphone;
a camera system being in electric communication with said microprocessor, said camera system further including:
a rear camera configured for being positioned on the front surface of the rear view mirror of the vehicle;
a pair of bumper cameras being configured for recording visuals of an exterior surrounding of the vehicle;
a pair of mirror cameras being configured for being positioned on a respective one of a pair of side mirrors of the vehicle; and
a roof camera being configured for being positioned on an interior surface of a roof of the vehicle;
a start button being in electric communication with said microprocessor.

2. The vehicular security camera assembly of claim 1, further comprising said microprocessor being configured for rendering commands from the user to execute actions based on the commands.

3. The vehicular security camera assembly of claim 2, further comprising said transceiver configured for having a global positioning system unit, said global positioning system unit being configured for locating the vehicle relative to the Earth, said agent being in wireless communication with said global positioning system unit.

4. The vehicular security camera assembly of claim 3, further comprising said microprocessor being configured for receiving electric power from a battery of the vehicle.

5. The vehicular security camera assembly of claim 4, further comprising said speaker producing audio output received from said agent from said transceiver of said microprocessor, said speaker being configured for being positioned on a front surface of the rear view mirror of the vehicle.

6. The vehicular security camera assembly of claim 5, further comprising said microphone being configured for receiving audio input from the user, said microphone being configured for being positioned on the front surface of the rear view mirror of the vehicle.

7. The vehicular security camera assembly of claim 6, further comprising said rear camera being configured for recording visuals of the interior of the vehicle.

8. The vehicular security camera assembly of claim 7, further comprising each of said bumper cameras being configured for being positioned on a respective one of a front bumper of the vehicle and the back bumper of the vehicle, each of said bumper cameras being configured for recording visuals in a 360 degree range of motion.

9. The vehicular security camera assembly of claim 8, further comprising said roof camera being configured for recording visuals of the interior of the vehicle in a 360 degree range of motion.

10. The vehicular security camera assembly of claim 9, further comprising said start button being an actuator configured for initiating recording of said camera system of the vehicle and initiating said transceiver, said start button being configured for being positioned on the front surface of the rear view mirror of the vehicle.

11. The vehicular security camera assembly of claim 10, further comprising a pair of stickers being configured for being coupled to a respective one of a pair of side windows of the vehicle, each of said stickers coupling to each of said windows by an adhesive material of a first side of each of said stickers, a second side of each of said stickers having a logo of said vehicular security camera assembly.

12. A vehicular security camera assembly configured for recording both the exterior and interior of a vehicle, the vehicular security camera assembly comprising:
a microprocessor being integrated within an interior of a vehicle, said microprocessor being configured for being positioned in a rear view mirror of the vehicle, said microprocessor being configured for rendering commands from the user to execute actions based on the commands, said microprocessor having a transceiver configured for engaging by wireless communication to an agent of an entity, said entity being a third party security company, said transceiver configured for having a global positioning system unit, said global positioning system unit being configured for locating the vehicle relative to the Earth, said agent being in wireless communication with said global positioning system unit, said microprocessor being configured for receiving electric power from a battery of the vehicle;
a speaker being in electric communication with said microprocessor, said speaker producing audio output received from said agent from said transceiver of said microprocessor, said speaker being configured for being positioned on a front surface of the rear view mirror of the vehicle;
a microphone being in electric communication with said microprocessor, said microphone being configured for receiving audio input from the user, said microprocessor being configured for rendering information provided by said microphone, said microphone being configured for being positioned on the front surface of the rear view mirror of the vehicle;
a camera system being in electric communication with said microprocessor, said camera system further including:
a rear camera configured for being positioned on the front surface of the rear view mirror of the vehicle, said rear camera being configured for recording visuals of the interior of the vehicle;
a pair of bumper cameras being configured for recording visuals of an exterior surrounding of the vehicle, each of said bumper cameras being configured for being positioned on a respective one of a front bumper of the vehicle and the back bumper of the vehicle, each of said bumper cameras being configured for recording visuals in a 360 degree range of motion;
a pair of mirror cameras being configured for being positioned on a respective one of a pair of side mirrors of the vehicle; and
a roof camera being configured for being positioned on an interior surface of a roof of the vehicle, said roof camera being configured for recording visuals of the interior of the vehicle in a 360 degree range of motion;
a start button being in electric communication with said microprocessor, said start button being an actuator configured for initiating recording of said camera system of the vehicle and initiating said transceiver, said start button being configured for being positioned on the front surface of the rear view mirror of the vehicle; and
a pair of stickers being configured for being coupled to a respective one of a pair of side windows of the vehicle, each of said stickers coupling to each of said windows by an adhesive material of a first side of each of said stickers, a second side of each of said stickers having a logo of said vehicular security camera assembly.

13. A method of activating a vehicle security camera assembly, the method including the step of:
pressing a start button to actuate a camera system integrated within a moving vehicle, said camera system can be actuated by speaking a first command into a microphone, said first command being “begin recording”, a global positioning system unit of a transceiver of a microprocessor begins locating the vehicle relative to the Earth;
calling an agent of an entity by speaking a second command into said microphone, said second command being “call agent”, said transceiver of said microprocessor begins to connect by wireless communication to said agent of said entity; and
communicating with said agent by speaking into said microphone and listening from a speaker.
